(19) United States
(12) Patent Application Publication
(10) Pub. No.: US 2015/0289197 A1
(43) Pub. Date: Oct. 8, 2015

(54) Channel Access Avoiding Windows Having Restricted Access

(71) Applicant: Nokia Corporation, Espoo (FI)

(72) Inventors: Chittabrata Ghosh, Fremont, CA (US); Klaus Doppler, Albany, CA (US)

(73) Assignee: Nokia Corporation, Espoo (FI)

(21) Appl. No.: 14/272,962

(22) Filed: May 8, 2014

Related U.S. Application Data
(63) Continuation-in-part of application No. 14/247,441, filed on Apr. 8, 2014.

(51) Int. Cl. H04W 48/08; H04W 88/08; H04W 84/12

(52) U.S. Cl. CPC H04W 48/08; H04W 84/12; H04W 88/08

(57) ABSTRACT

A method including determining if a period between two beacons is to have at least one Periodic Restricted Access Window (PRAW), where at least one of the beacons is a Short Beacon (SB); and based upon the determining if the period has at least one Periodic Restricted Access Window (PRAW), providing in a RAW Parameter Set (RPS) an indication regarding the at least one Periodic Restricted Access Window (PRAW).

### CROSS REFERENCE TO RELATED APPLICATION

This application is a continuation-in-part of copending application Ser. No. 14/147,441 filed Apr. 8, 2014 which is hereby incorporated by reference in its entirety.

### BACKGROUND

1. Technical Field

The exemplary and non-limiting embodiments relate generally to channel access and, more particularly, to channel access avoiding windows having restricted access.

2. Brief Description of Prior Developments

The following abbreviations that may be found in the specification and/or the drawing figures are defined as follows:
AP—Access point
eNB—evolved NodeB, such as in an evolved universal mobile telecommunication system (E-UMTS)
FCS—frame check sequence
IEEE—The Institute of Electrical and Electronics Engineers
MAC—Media Access Control
MCS—Modulation and Coding Scheme
NAV—Network Allocation Vector
NCE—Network Controller Element
PHY—physical layer
PPDU—PHY Protocol Data Unit
PSDU—Physical Layer Convergence Procedure (PLCP) Service Data Unit
RID—Response Indication Deferral
RRC—Radio Resource Control
STA—Station
TIM—Traffic Indication Map
TxOP—Transmit Opportunity
UE—User Equipment
WLAN—Wireless Local Area Network

IEEE 802.11 is a set of media access control (MAC) and physical layer (PHY) specifications for implementing wireless local area network (WLAN) communication. They are created and maintained by the IEEE LAN/MAN Standards Committee (IEEE 802). The standard and amendments provide the basis for wireless network products generally called Wi-Fi.

### SUMMARY

The following summary is merely intended to be exemplary. The summary is not intended to limit the scope of the claims.

In accordance with one aspect, an example method comprises determining if a period between two beacons is to comprise at least one Periodic Restricted Access Window (PRAW), where at least one of the beacons comprises a Short Beacon (SB); and based upon the determining if the period comprises the at least one Periodic Restricted Access Window (PRAW), providing in a RAW Parameter Set (RPS) an indication regarding the at least one Periodic Restricted Access Window (PRAW).

In accordance with another aspect, an example apparatus comprises at least one processor; and at least one memory including computer program code, the at least one memory and the computer program code configured to, with the at least one processor, cause the apparatus at least determine if a period between two beacons is to comprise at least one Periodic Restricted Access Window (PRAW), where at least one of the beacons comprises a Short Beacon (SB); and based upon the determining if the period comprises the at least one Periodic Restricted Access Window (PRAW), provide in a RAW Parameter Set (RPS) an indication regarding the at least one Periodic Restricted Access Window (PRAW).

In accordance with another aspect, an example apparatus is provided in a non-transitory program storage device readable by a machine, tangibly embodying a program of instructions executable by the machine for performing operations, the operations comprising determining if a period between two beacons is to comprise at least one Periodic Restricted Access Window (PRAW), where at least one of the beacons comprises a Short Beacon (SB); and based upon the determining if the period comprises the at least one Periodic Restricted Access Window (PRAW), providing in a RAW Parameter Set (RPS) an indication regarding the at least one Periodic Restricted Access Window (PRAW).

In accordance with another aspect, an example method comprises providing an indication with a first bit if a Periodic Restricted Access Window (PRAW) is at least substantially adjacent to a Non-Periodic Restricted Access Window (NRAW) in a period between two beacons, where at least one of the beacons is a Short Beacon (SB); and providing an indication with a second bit if the Periodic Restricted Access Window (PRAW) is before or after the Non-Periodic Restricted Access Window (NRAW).

In accordance with another aspect, an example apparatus comprises at least one processor; and at least one memory including computer program code, the at least one memory and the computer program code configured to, with the at least one processor, cause the apparatus at least provide an indication with a first bit if a Periodic Restricted Access Window (PRAW) is adjacent to a Non-Periodic Restricted Access Window (NRAW) in a period between two beacons, where at least one of the beacons is a Short Beacon (SB); and provide an indication with a second bit if the Periodic Restricted Access Window (PRAW) is before or after the Non-Periodic Restricted Access Window (NRAW).

In accordance with another aspect, an example apparatus is provided in a non-transitory program storage device readable by a machine, tangibly embodying a program of instructions executable by the machine for performing operations, the operations comprising providing an indication with a first bit if a Periodic Restricted Access Window (PRAW) is adjacent to a Non-Periodic Restricted Access Window (NRAW) in a period between two beacons, where at least one of the beacons is a Short Beacon (SB); and providing an indication with a second bit if the Periodic Restricted Access Window (PRAW) is before or after the Non-Periodic Restricted Access Window (NRAW).

### BRIEF DESCRIPTION OF THE DRAWINGS

The foregoing aspects and other features are explained in the following description, taken in connection with the accompanying drawings, wherein:

FIG. 1 is a diagram illustrating an example network;

FIG. 2 is a diagram illustrating some of the components of the devices shown in FIG. 1;

FIG. 3 is diagram illustrating examples of long beacons, short beacons and PRAW with an AP, a TIM STA (STA1) and a non-TIM STA (STA2);

FIG. 4 is diagram illustrating examples of long beacons, short beacons, NRAW and PRAW;

FIG. 5 is an example of a NRAW and a PRAW during an entire beacon period;

FIG. 6 is an example of no NRAW and no PRAW in a beacon period;

FIG. 7 is an example of a NRAW and PRAW in a beacon period with a leading non-RAW access period in front;

FIG. 8 is an example of a NRAW and PRAW in a beacon period with a trailing non-RAW access period;

FIG. 9 is an example of a short beacon;

FIG. 10 is a diagram illustrating an example method;

FIG. 11 is a diagram illustrating an example method;

FIG. 12 is a diagram illustrating an example method;

FIG. 13 is a diagram illustrating beacons and multiple NRAW and PRAW in the period between the beacons, and an example format for a RAW Parameter Set (RPS) element;

FIG. 14 is a diagram illustrating beacons and multiple NRAW and PRAW in the period between the beacons;

FIG. 15 is a diagram illustrating beacons and multiple NRAW and PRAW in the period between the beacons;

FIG. 16 is a diagram illustrating beacons and multiple NRAW in the period between the beacons, where the NRAWs are immediately adjacent one another;

FIG. 17 is a diagram illustrating an example of a format for a RAW Assignment field;

FIG. 18 is a diagram illustrating an example of a format for a RAW Control field in a RAW Assignment field;

FIG. 19 is a diagram illustrating an example method; and

FIG. 20 is a diagram illustrating an example method.

### DETAILED DESCRIPTION OF EMBODIMENTS

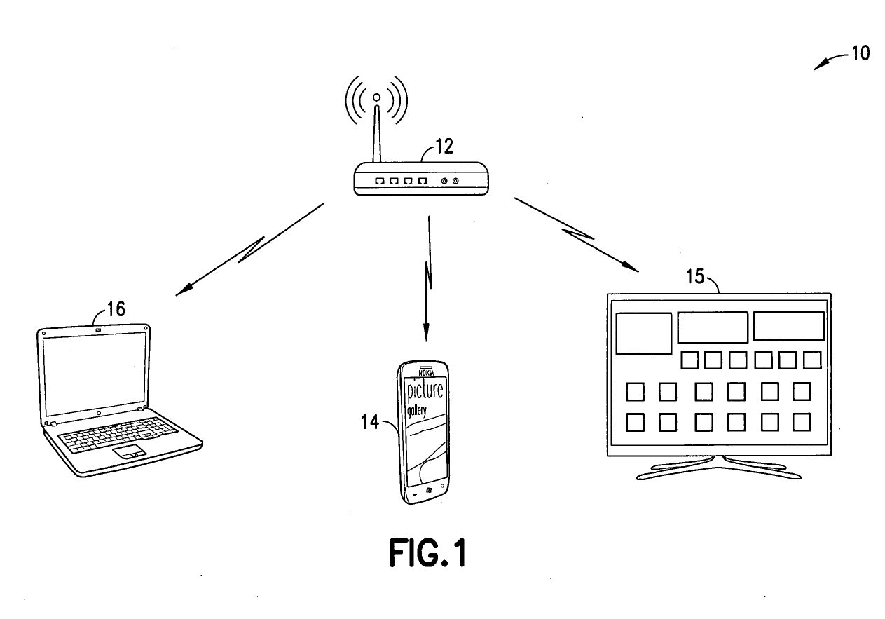

Referring to FIG. 1, a wireless communication system 10 is shown which incorporates features of example embodiments. Although the features will be described with reference to the example embodiments shown in the drawings, it should be understood that features can be embodied in many alternate forms of embodiments. The system 10 in this example is a wireless local area network (WLAN). However, features as described herein may be used with any suitable type of wireless communication system, such as 3GPP based technologies, other IEEE based technologies or the like.

In the example shown the system 10 includes an access node 12 and a plurality of devices 14, 15, 16 which may communicate wirelessly with the access node 12. The access node 12 may be an access point (AP), such as a wireless router for example, connected to the Internet (not shown) for example. The devices may comprise, for example, one or more smartphones 14, one or more network capable televisions 15, and/or one or more computers 16. These are merely examples of the devices. Any other suitable device may be connect to the wireless network including, for example, smart appliances, printers, home security devices, gaming systems, tablet computers, etc.

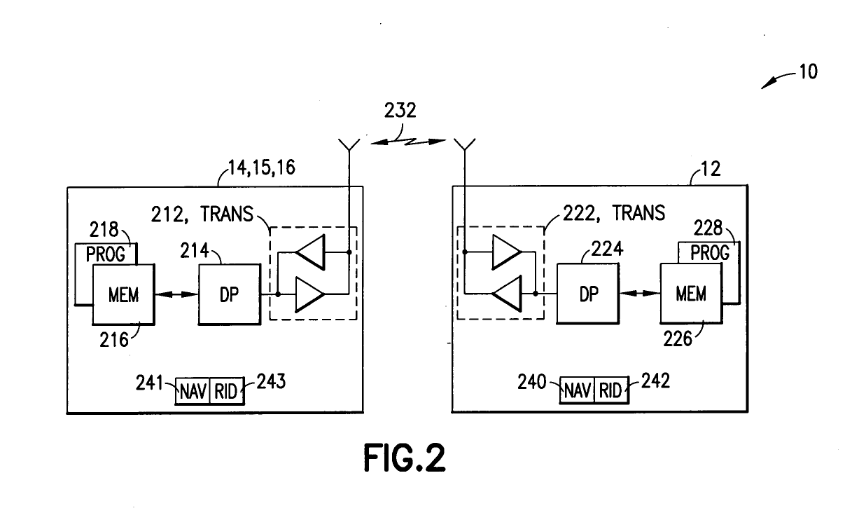

Referring also to FIG. 2, the wireless network 10 is adapted for communication over wireless links 232 between the access node 12 and the various devices 14, 15, 16. Features as described herein are not restricted to WLAN infrastructure basic service set (BSS). Features may be provided, for example, in an ad hoc network wherein the wireless links may be between two (non-AP) stations. Thus, according to an example embodiment, the access node 12 may be replaced by a station which is not an access node or an access point (AP). It may be, for example, a non-AP station for a wireless local area network.

Each of the devices 14, 15, 16 may be a station (STA) in the network 10. Each device 14, 15, 16 may include a controller, such as a computer or a data processor (DP) 214, and a computer-readable memory medium embodied as a memory (MEM) 216 that stores a program of computer instructions (PROG) 218. Each device 14, 15, 16 may also include a suitable wireless interface, such as radio frequency (RF) transceiver 212, for bidirectional wireless communications with the access node 12 via one or more antennas. Although features are being described herein with reference to the whole devices 12, 14, 15, 16, it should be noted that features as described herein may be provided in a subcomponent or assembly which is assembled into the devices 12, 14, 15, 16. For example, features by be provided in a chipset which is assembled into one or more of the devices 12, 14, 15, 16. The devices 12, 14, 15, 16 may, in some embodiments, also be referred to as a user equipment (UE).

The access node 12 also includes a controller, such as a computer or a data processor (DP) 224, a computer-readable memory medium embodied as a memory (MEM) 226 that stores a program of computer instructions (PROG) 228, and a suitable wireless interface, such as RF transceiver 222, for communication with the device 14, 15, 16 via one or more antennas. The access node 12 may be coupled via a data/control path to a NCE. The path may be implemented as an interface. The access node 12 may also be coupled to another access node via a data/control path, which may be implemented as an interface. The access node, in some embodiments, may be an eNB (evolved NodeB).

At least one of the PROGs 218, 228 is assumed to include program instructions that, when executed by the associated DP, enable the device to operate in accordance with exemplary embodiments of this invention, as will be discussed below in greater detail. That is, various exemplary embodiments of this invention may be implemented at least in part by computer software executable by the DP 214 of the device; and/or by the DP 224 of the access node, or by hardware, or by a combination of software and hardware (and firmware).

In general, the various embodiments of the device can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 216, 226 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 212 and 222) may be of any type suitable to the local technical environment and may be implemented using any suitable communication technology such as individual transmitters, receivers, transceivers or a combination of such components.

As a description of an example, the computer 16 will be used as being in communication with the access node 12. Features are equally applicable to any of the other stations (STAs). According to an example embodiment, there may be two categories of stations (STAs); a traffic indication map (TIM) STA and a non-TIM STA. TIM STAs may be required to decode long and/or short beacons for indication of presence of their buffered downlink data at the access point (AP). This may be an IEEE 802.11 network for example. Features as described herein may be used with wireless technologies other than IEEE 802.11, such as 3GPP based technologies for example. The carrier sensing mechanisms of the network 10 are defined in order to restrict transmissions while a STA (12, 14, 15 or 16) is currently transmitting. In general, a STA's state may be in any one mode at a particular time, either in receive (Rx) mode or in transmit (Tx) mode, and not in both mode at the same time. In an example embodiment, the network 10 may use more than one virtual carrier sensing mechanism, namely NAV (Network Allocation Vector) and RID (Response Indication Deferral). However, in an alternate example more than two virtual carrier sensing mechanisms could be used. In another example embodiment, only one virtual carrier sensing mechanism could be used. The devices 12, 14, 15, 16 may have NAV counters 240, 241 and RID counters 242, 243 schematically illustrated in FIG. 2. Organizations are currently trying to agree on a specification for IEEE 802.11ah, but no final agreement has been reached yet. In some proposals for IEEE 802.11ah there are two counters, a NAV counter and a RID counter, both of which need to be zero to conclude that the medium is idle. Response Indication Deferral (RID) has been proposed for the IEEE 802.11ah standard as a second virtual sensing mechanism to the conventional NAV virtual carrier sensing mechanism. Features as described herein may be used with one or more any suitable type of virtual sensing mechanism; not necessarily only NAV and/or RID. Use of NAV and RID in this description is merely an example.

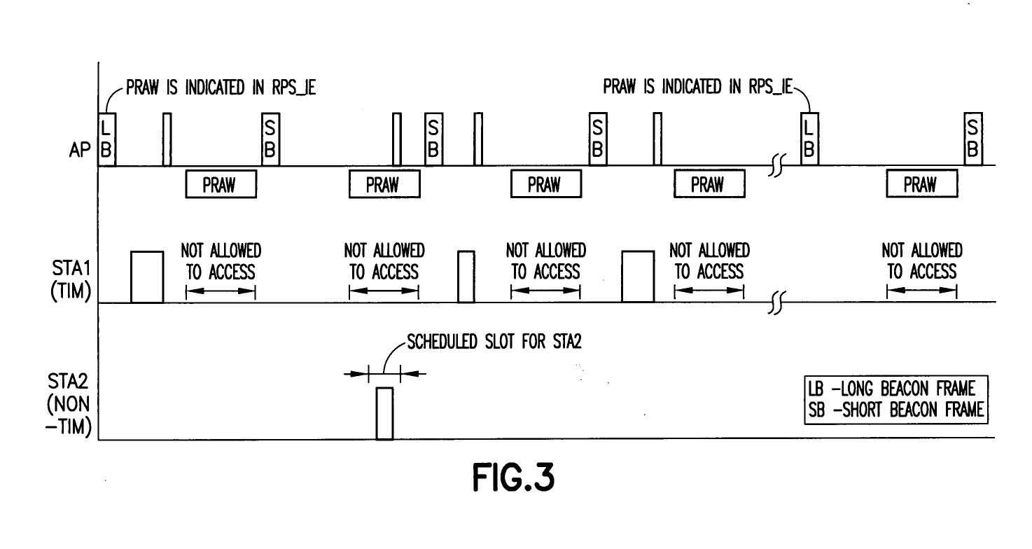

Referring also to FIG. 3, the example transmission from the access node 12 functioning as an access point (AP) may comprise two types of beacons: long beacons (LB) and short beacons (SB). The period between two LBs can vary from about 100 ms to 500 ms for example. There can be one or more SBs within the LB interval. In A TIM STA decodes long and short beacons for indication of presence of their buffered downlink data at the access point (AP).

A short beacon (SB) period is one or more of the following: a period from the long beacon (LB) to the first short beacon (SB) within the long beacons (LB) period, a period between to two consequent short beacons (SB) within the LB period, and a period from the last short beacons (SB) within the LB period to the next long beacon (LB).

A Restricted Access Window (RAW) is a group-based medium access where a group of STAs are allowed to access the medium for a specific duration. During this RAW duration STAs in other groups are prohibited from channel access. A RAW is a general term covering all RAW types. A Periodic RAW (PRAW) is a type of RAW which has periodical allocations and can be used to protect non-TIM STAs from TIM STAs. Another type of RAW is a Non-periodical Restricted Access Window (NRAW). In this example, two types of group reservations are provided for a SB period: Non-periodical Restricted Access Windows (NRAWs) can be used for a group of TIM STAs, and Periodic RAWs (PRAWs) can be used to protect non-TIM STAs from TIM STAs. In another example, zero or one type of group reservations may be provided for a SB period. Periodic RAW (PRAW) is mainly scheduled for non-TIM STAs such that their transmissions are protected from TIM STAs. NRAW and PRAW parameters are indicated in RAW Parameter Set (RPS) information element included in beacons and Probe Response frames. While RPS elements are included in almost every short beacon for TIM STA access information, full PRAW information is only included periodically in long beacons LB. The TIM STAs are prohibited from channel access during the scheduled PRAW periods.

NRAW allocations may vary between SB periods, but PRAW allocations are repeated similarly in every SB period. Therefore, NRAWs are scheduled in both LB and SB, whereas PRAWs are scheduled only in LB. A SB period may contain 0 or more NRAWs, and 0 or more PRAWs.

Within a SB period, both TIM STAs and non-TIM STAs may contend during non-reserved periods. However, TIM STAs may not contend during a PRAW period. If a TIM STA does not decode a long beacon LB correctly, or if the TIM STA wakes/associates after the LB transmission, without features as described herein, the TIM STA does not know whether there is some slot during a SB period in which it may contend. This is because, without features as described herein, the TIM STA would not be able to know, based on the SB, whether the SB period contains PRAW allocation or not. Thus, without features as described herein, the TIM STA would need to wait until the next LB. This may lead to unnecessary delay and non-efficient spectrum usage.

TIM STAs that are not indicated in the RAW Group are prohibited from channel access during the RAW durations. The TIM STAs are also prohibited from channel access during the PRAW periods as indicated in the FIG. 3. As shown in the FIG. 3, PRAW schedule indications are done in long beacons; not in short beacons. STA 1 in FIG. 3, such as 16 being a TIM STA, is prohibited while STA 2, such as 15 being a non-TIM STA, is allowed to access PRAW period. If a TIM STA is unable to decode a long beacon for any reason, it is now unaware of the PRAW schedules during a short beacon interval. In the FIG. 3, STA 1 is assumed to have received the long beacon correctly.

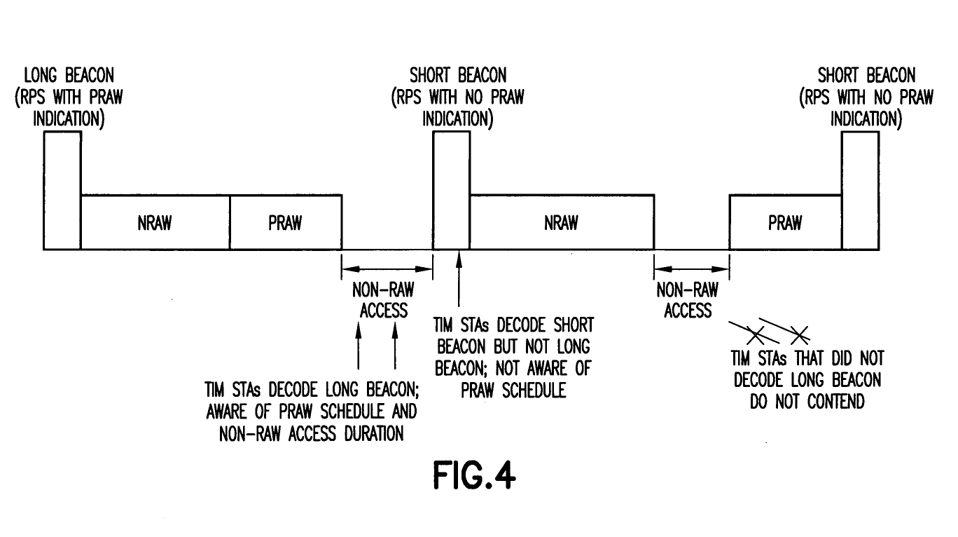

Referring also to FIG. 4, without features as described herein, in the case when a TIM STA did not decode the long beacon LB, but decoded a short beacon SB, and if it is not scheduled to access the NRAW duration, such as not within the NRAW Group for example, then within the short beacon interval the TIM STA would not be allowed within the NRAW duration. Since it is not sure about any PRAW schedule within this short beacon interval, it will be unable to transmit during the rest of the interval outside the RAW durations. In other words, based on the existing and proposed IEEE 802.11 standards, if TIM STAs are unable to decode the long beacon, they will be unable to access medium for long intervals; until they are part of one or more scheduled RAW Groups.

Getting information on all NRAWs and PRAWs would required getting detailed PRAW information in the SB. After that, the TIM STA could calculate non-RAW periods which can be used to contend channel access. However, providing information on PRAW allocation in each SB would require up to 9 bytes. Since, the PRAWs are periodical, adding this much information to SBs is considered too burdensome.

With features as described herein, in order to access the medium outside the NRAW and PRAW durations (non-RAW access), a STA may be made aware of the information about scheduled PRAW (start time and duration) and NRAW durations and their start times. Features as described herein provide a novel method of providing this information to the TIM STAs for non-RAW medium access. Features as described herein may be used to prevent prohibition of channel access of TIM STAs that have not received the long beacon correctly, or might have woken up after the long beacon transmission.

Technical Implementation

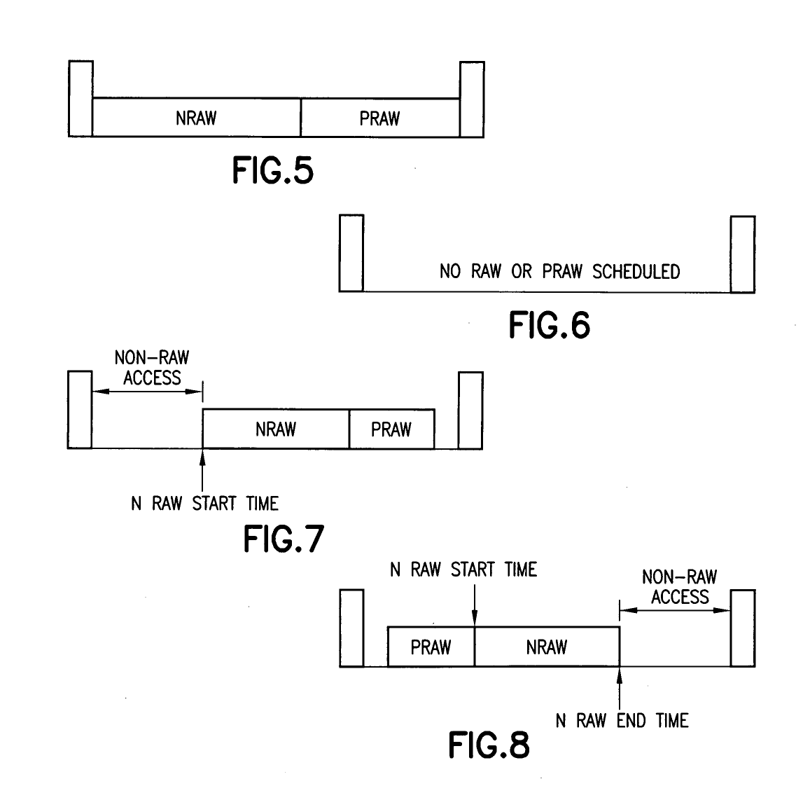

In one example embodiment two (2) bits are added to a short beacon SB to indicate a possible existence of a non-RAW slot. This may be used by a TIM STA that has missed the complete long beacon LB. This information may be included in the short beacon SB, especially in short beacon frames to enable the TIM STAs to contend for medium in non-RAW access intervals. An example of the two (2) bit indication is as follows:
00: The AP indicates that there is no schedule for non-RAW Access as indicated in FIG. 5.
01: The AP indicates that the entire beacon interval is allowed for non-RAW access as shown in FIG. 6.
10: The AP indicates that STAs can access the non-RAW interval from the end of beacon transmission to the beginning of NRAW Start Time (in RPS element) as shown in FIG. 7.
11: The AP indicates that STAs can access the non-RAW interval from the end of NRAW End Time (in RPS element) to the end of beacon interval as shown in FIG. 8.

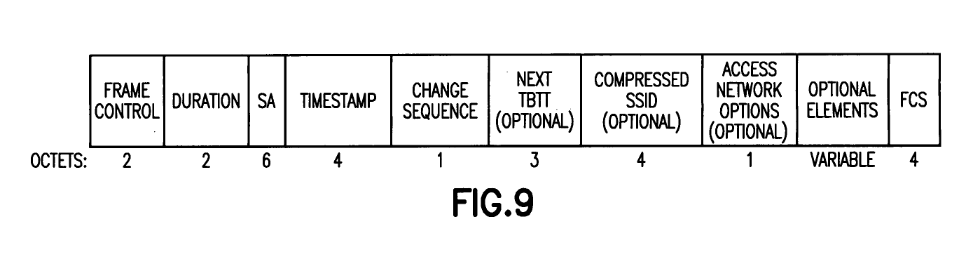

Referring also to FIG. 9 an example of a short beacon is shown. The two (2) bit indication may be included in the optional elements frame. The beacon shown in FIG. 9 is merely an example and should not be considered as limiting. One or more frames could be provided for the indication, and more or less than two (2) bits could be provided for the indication. Other details or specifics could be included with the indication. It may be desired to add some other information here and, thus, the result may be 3 or 4 bits instead of two.

The immediate advantage of this rule is to allow 802.11 TIM STAs to access medium in intervals outside the RAW durations and not within the scheduled PRAW periods. This also provides a method of energy savings for the TIM STAs. Features are fairly simple to implement; requiring only two (2) bits to allow a TIM STA to contend during a SB period in case it has missed a LB. The indication does not add the entire RAW assignment information of PRAW to the RPS element of SB, but instead uses a two bit indication, which indicates sufficient information for most use cases and thereby provides an advantage over trying to provide all the information in the short beacon SB.

In case a SB period contains more than one NRAW allocation or more than one PRAW, that may be a minor issue. However, most embodiments do not comprise multiple NRAWs or PRAWs within a single SB period. The non-presence of a RAW does not need to be indicated. The proposed solution provides a simple method to signal the presence of a PRAW either at the end or beginning of the beacon interval. It may put some restrictions on how PRAWs can be scheduled, but in an example embodiment the indication only requires 2 bits in a RPS element.

One may assume that, in most embodiments, the short beacon SB period has 0 or 1 NRAW and 0 or 1 PRAW. In a case there is both a NRAW and a PRAW, it is assumed that they are consecutive, or that a slot between them is not considered. In a case where only PRAW and no NRAW is scheduled, one may define a short RPS only indicating the RAW start time or RAW duration in addition to the two (2) bits. The RAW start time and Duration may be that of the PRAW.

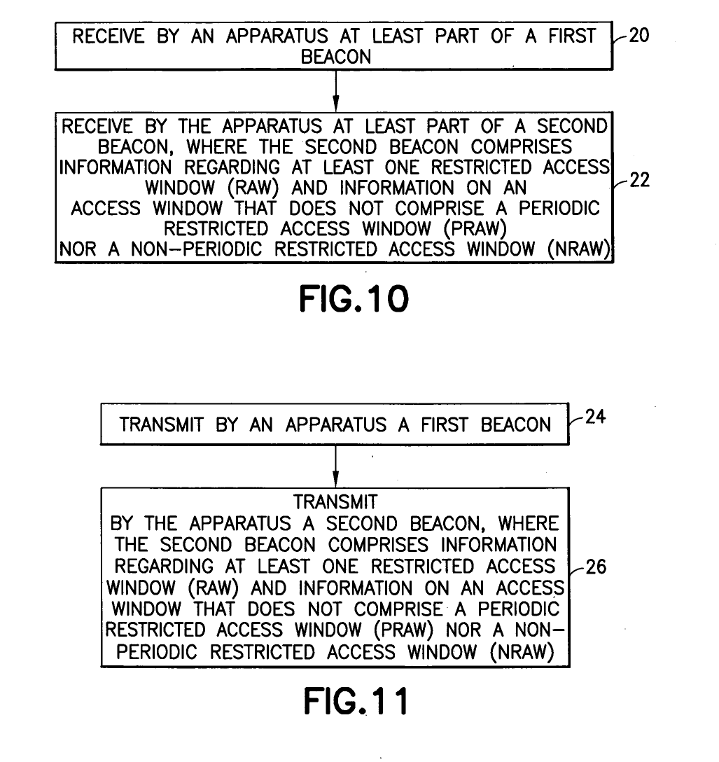

Referring also to FIG. 10, an example method may comprise receiving by an apparatus at least part of a first beacon as indicated by block 20, where the first beacon comprises information regarding at least a first periodic restricted access window (PRAW); and receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW) as indicated by block 22, where the part of the second beacon received by the apparatus does not comprise complete information regarding a second periodic restricted access window (PRAW) of the second beacon. The information regarding at least one restricted access window (RAW) may comprise full information of NRAW or a subset of PRAW information in case the RAW. In case the second beacon does not have any NRAW, the information regarding at least one restricted access window (RAW) may need to comprise a subset of PRAW information to get its start time and end time values. The first beacon may be a long beacon and the second beacon may be a short beacon.

The first beacon may be larger than the second beacon. The first beacon may be a long beacon and the second beacon may be a short beacon. The information on the access window that does not comprise a periodic restricted access window (PRAW) nor a non-periodic restricted access window (NRAW) may comprise two bits which indicate at least one of no such access window, an entire beacon interval is available, a channel is available from an end of beacon transmission to the beginning of a RAW Start Time, the channel is available from the end of a RAW End Time to the end of a beacon interval. The apparatus may be a traffic indication map (TIM) station for a wireless local area network, and where the at least part of the first beacon and the second beacon are received from an access point. The first and the second periodic access windows may reserved for non-traffic indication map (non-TIM) stations. The apparatus may not be allowed to contend for medium access during any periodic restricted access window.

An example embodiment may be provided in an apparatus comprising at least one processor; and at least one non-transitory memory including computer program code, the at least one memory and the computer program code configured to, with the at least one processor, cause the apparatus at least to receive at least part of a first beacon, where the first beacon comprises information regarding at least a first periodic restricted access window (PRAW); and receive at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

An example embodiment may be provided in a non-transitory program storage device such as 216 and 218 for example readable by a machine, tangibly embodying a program of instructions executable by the machine for performing operations, the operations comprising receiving by an apparatus at least part of a first beacon, where the first beacon comprises information regarding at least a first periodic restricted access window (PRAW); and receiving by the apparatus at least part of a second beacon, where the second beacon comprises information regarding at least one restricted access window (RAW) and information on an access window that does not comprise a periodic restricted access window (PRAW) nor a non-periodic restricted access window (NRAW), where the part of the second beacon received by the apparatus does not comprise complete information regarding a second periodic restricted access window (PRAW) of the second beacon.

Referring also to FIG. 11, an example method may comprise transmitting by an apparatus a first beacon as indicated by block 24, where the first beacon comprises information regarding at least a first periodic restricted access window (PRAW); and transmitting by the apparatus a second beacon as indicated by block 26, where the second beacon comprises information regarding at least one restricted access window (RAW) and information on an access window that does not comprise a periodic restricted access window (PRAW) nor a non-periodic restricted access window (NRAW).

An example embodiment may be provided in an apparatus comprising at least one processor; and at least one non-transitory memory including computer program code, the at least one memory and the computer program code configured to, with the at least one processor, cause the apparatus at least to transmit by the apparatus a first beacon, where the first beacon comprises information regarding at least a first periodic restricted access window (PRAW); and transmit by the apparatus a second beacon, where the second beacon comprises information regarding at least one restricted access window (RAW) and information on an access window that does not comprise a periodic restricted access window (PRAW) nor a non-periodic restricted access window (NRAW).

An example embodiment may be provided in a non-transitory program storage device readable by a machine, tangibly embodying a program of instructions executable by the machine for performing operations, the operations comprising transmitting by the machine a first beacon, where the first beacon comprises information regarding at least a first periodic restricted access window (PRAW); and transmitting by the machine a second beacon, where the second beacon comprises information regarding at least one restricted access window (RAW) and information on an access window that does not comprise a periodic restricted access window (PRAW) nor a non-periodic restricted access window (NRAW).

Any combination of one or more computer readable medium(s) may be utilized as the memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

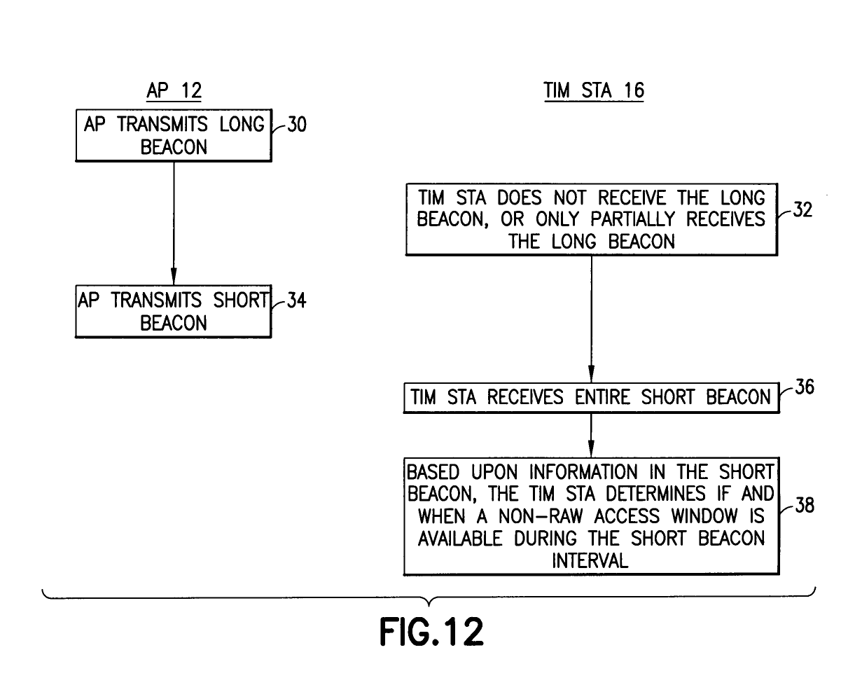

Referring also to FIG. 12, in an example method the AP may transmit a long beacon as indicated by block 30, and the TIM STA does not receive the ling beacon, or only partially receives the long beacon as indicated by block 32. The AP then subsequently transmits a short beacon as indicated by block 34, where the short beacon comprises the two (2) bit information noted above (as well as the other short beacon information). The TIM STA receives the short beacon as indicated by block 36 and, as indicated by block 38, the TIM STA is able to use the information to determine if and when a Non-RAW access window is available during the short beacon interval, such as non-RAW access windows shown in FIGS. 6, 7 and 8 for example.

An example embodiment may be provided in an apparatus comprising means for receiving by an apparatus at least part of a first beacon, where the first beacon comprises information regarding at least a first periodic restricted access window (PRAW); and means for receiving by the apparatus at least part of a second beacon, where the second beacon comprises information regarding at least one restricted access window (RAW) and information on an access window that does not comprise any restricted access window, where the part of the second beacon received by the apparatus does not comprise complete information regarding a second periodic restricted access window (PRAW) of the second beacon.

An example embodiment may be provided in an apparatus comprising means for transmitting by an apparatus a first beacon, where the first beacon comprises information regarding at least a first periodic restricted access window (PRAW); and means for transmitting by the apparatus a second beacon, where the second beacon comprises information regarding at least one restricted access window (RAW) and information on an access window that does not comprise any restricted access window.

An example method may comprise receiving by an apparatus a first beacon frame comprising complete information on at least a first periodic restricted access window; and receiving by the apparatus a second beacon frame comprising information on at least one restricted access window and information on an access window that does not comprise any restricted access window, wherein the second beacon frame does not comprise complete information on a second periodic restricted access window of a beacon period corresponding to the second beacon frame. The TIM STA may receive the long beacon (first beacon frame) getting all information on periodic RAW. Then the TIM STA might miss another long beacon and receives a short beacon (second beacon frame), and that short beacon would not comprise complete information on the PRAW, but indicates an access window part that is free from non-periodic and periodic RAWs. The first beacon frame may be larger than the second beacon frame. The first beacon frame may be a long beacon and the second beacon frame may be a short beacon. The information on the access window that does not comprise any restricted access window may comprise two bits which can be used to indicate at least one of the following: no such access window, the entire beacon interval is available, the channel is available from the end of beacon transmission to the beginning of RAW Start Time, the channel is available from the end of RAW End Time to the end of beacon interval. The apparatus may be a traffic indication map station for a wireless local area network, and the first beacon frame and the second beacon frame may be received from an access point. The first and the second periodic access windows may be reserved for non-TIM stations. The apparatus may not be allowed to contend for medium access during any periodic restricted access window.

An example method may comprise receiving by an apparatus a beacon, where the beacon comprises information regarding a restricted access window (RAW); and receiving in the beacon information regarding a non-restricted access window, where the non-restricted access window does not comprise the non-periodic restricted access window (NRAW) and does not comprise a periodic restricted access window (PRAW), where the information comprises only partial information regarding the periodic restricted access window (PRAW) or indicates absence of the periodic restricted access window (PRAW) during a beacon interval.

The beacon may be a second beacon and the method further comprises receiving by the apparatus at least part of a first beacon before the second beacon, where the first beacon comprises information regarding at least a first periodic restricted access window (PRAW), where the first beacon is larger than the second beacon. The beacon may be a second beacon and the method further comprises receiving by the apparatus at least part of a first beacon before the second beacon, where the first beacon is a long beacon and the second beacon is a short beacon. The information comprises two bits which indicate at least one of no such access window, an entire beacon interval is available, a channel is available from an end of beacon transmission to the beginning of a RAW Start Time, the channel is available from the end of a RAW End Time to the end of a beacon interval. The apparatus may be a traffic indication map (TIM) station for a wireless local area network, where the beacon is a second beacon and the method further comprises receiving by the apparatus at least part of a first beacon before the second beacon, and where the at least part of the first beacon and the second beacon are received from an access point. The periodic restricted access window (PRAW) may be reserved for non-traffic indication map (non-TIM) stations. The apparatus may be prevented to contend for medium access during any periodic restricted access window (PRAW).

An example embodiment may be provided in an apparatus comprising at least one processor; and at least one non-transitory memory including computer program code, the at least one memory and the computer program code configured to, with the at least one processor, cause the apparatus at least to receive by the apparatus a beacon, where the beacon comprises information regarding a restricted access window (RAW); and receive in the beacon information regarding a non-restricted access window, where the non-restricted access window does not comprise a non-periodic restricted access window (NRAW) and does not comprise a periodic restricted access window (PRAW), where the information comprises only partial information regarding the periodic restricted access window (PRAW) or indicates absence of the periodic restricted access window (PRAW) during a beacon interval.

An example embodiment may be provided in a non-transitory program storage device readable by a machine, tangibly embodying a program of instructions executable by the machine for performing operations, the operations comprising receiving by an apparatus a beacon, where the beacon comprises information regarding a restricted access window (RAW); and receiving in the beacon information regarding a non-restricted access window, where the non-restricted access window does not comprise a non-periodic restricted access window (NRAW) and does not comprise a periodic restricted access window (PRAW), where the information comprises only partial information regarding the periodic restricted access window (PRAW) or indicates absence of the periodic restricted access window (PRAW) during a beacon interval.

The examples described above generally indicate non-RAW medium access with one RAW and one PRAW scheduled. However, in some instances there are multiple NRAWs and/or PRAWs scheduled within a beacon interval, and the NRAWs may not be adjacent to each other. Features as described herein may be used to indicate non-RAW channel access times when there are multiple NRAWs and/or PRAWs scheduled that are not adjacent to each other.

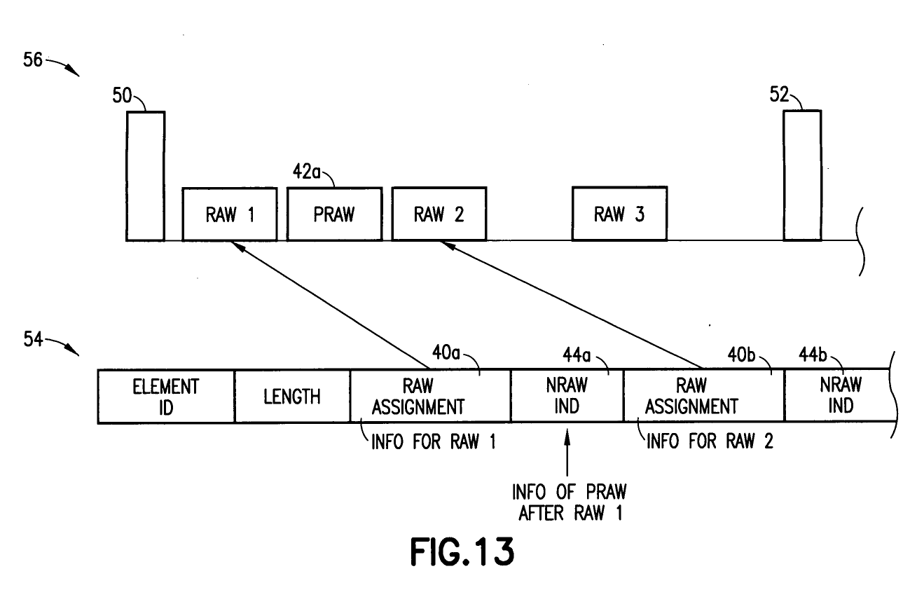

The RAW Parameter Set (RPS) element provides information of the RAW group, RAW Start Time and Duration for each of the RAWs scheduled within a Beacon interval. Referring also to FIG. 13, an example of a RPS element format 54 is shown with its corresponding diagram 56 illustrating an example period between two beacons 50, 52; where one of the beacons is a Short Beacon (SB). FIG. 13 illustrates a new modified RPS element enabling TIM STAs to access medium. The RPS element format 54 comprises a first RAW Assignment field 40a which provides information for the first NRAW (RAW 1), a second RAW Assignment field 40b for the second NRAW (RAW 2), and so on for the remaining NRAWs within a Beacon interval. A new NRAW Indicator field 44 is included in the RPS element format for each RAW Assignment field 40. In this example each NRAW Indicator field 44 comprises two (2) bits. However, in an alternate example more than two bits may be provided.

The first bit of the NRAW Indicator field 44 indicates whether a PRAW is scheduled adjacent (or substantially adjacent) to the specific NRAW for which the RAW Assignment field 40 is designated for. If the first bit is set to 0, then the second bit is ignored. If the first bit is set to 1, then the second bit indicates whether the PRAW is scheduled to the left or right of this NRAW. For example, for the scenario in FIG. 13, NRAW Ind 44a after the first RAW Assignment field 40a shall be set to 11. This indicates that a PRAW 42a is adjacent (or substantially adjacent) the RAW 1 and that the PRAW is located to the right of RAW 1. In another example, the NRAW Ind 44b after the second RAW Assignment field 40b shall be set to 10. This indicates that the PRAW 42a is located to the left of RAW 2. The NRAW Ind after the third RAW Assignment field shall be set to 00, indicating to STAs that there is no PRAW scheduled between RAW2 and RAW 3, and also that no PRAW is scheduled after RAW 3.

In addition to the above new RPS element format, other software programming may be provided with additional rules to allow for a situation where a long beacon is not received in its entirety. The software programming may include the following rules for example:
Rule for NRAW Indication with PRAWs on both sides of a NRAW
Rule for no NRAW Indication
Rule for no non-RAW Access
Rule for non-RAW Access
Rule for PRAW Indication with no assigned RAWs

Rule for NRAW Indication with PRAWs on Both Sides of a NRAW:

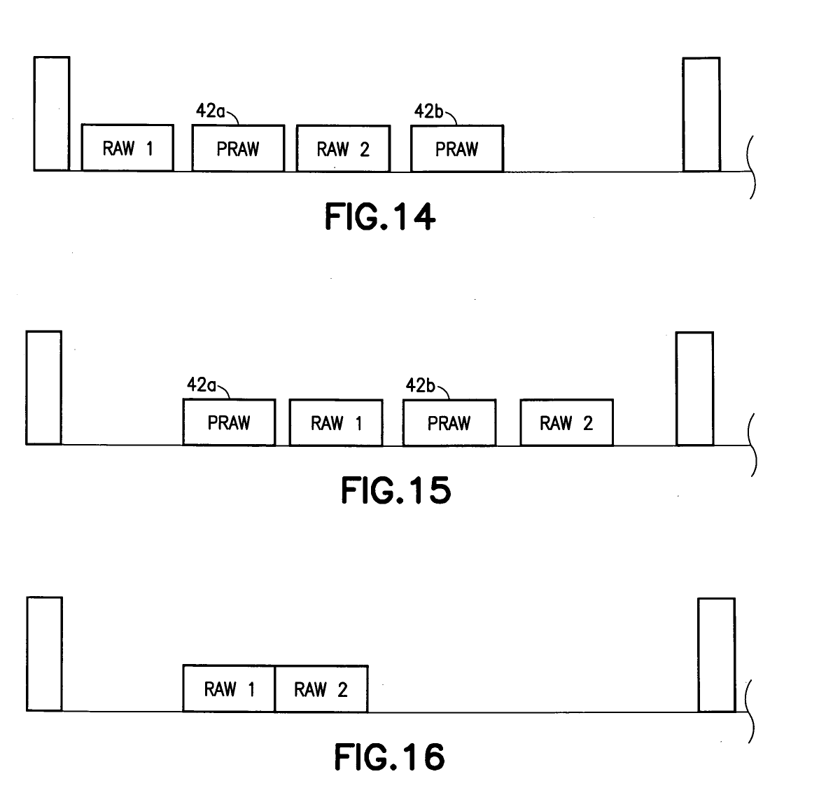

Referring also to FIG. 14 for example, there may be a PRAW 42b on a right side of a NRAW (RAW 2 in this example) and there is another PRAW 42a on the left side of the RAW 2. Bit 2 of the NRAW Indication 44 (corresponding to the RAW 2) may indicate a PRAW location on either side of the NRAW (RAW 2), but is not able to indicate both sides. The Access Point (AP) may be programmed to regulate the indication in this case. For example, if the NRAW Ind 44 for the previous RAW Assignment (for RAW 1) already indicates the PRAW 42a is scheduled between the two NRAWs (PRAW 42b right of RAW 2 and PRAW 42a left of RAW 2), then the AP may use the second bit of NRAW Ind 44 after the later RAW Assignment (corresponding to RAW 2) to indicate that the PRAW 42b is scheduled on its other (right) side. Referring also to FIG. 15, if the NRAW Ind 44 for the previous RAW Assignment (for RAW 1 in this example) indicates the PRAW 42a is scheduled to its left, then the second bit of the NRAW Ind 44 of the later RAW Assignment (for RAW 2) may indicate the second PRAW 42b is scheduled left of the RAW 2; between the two NRAWs.

Rule for No NRAW Ind:

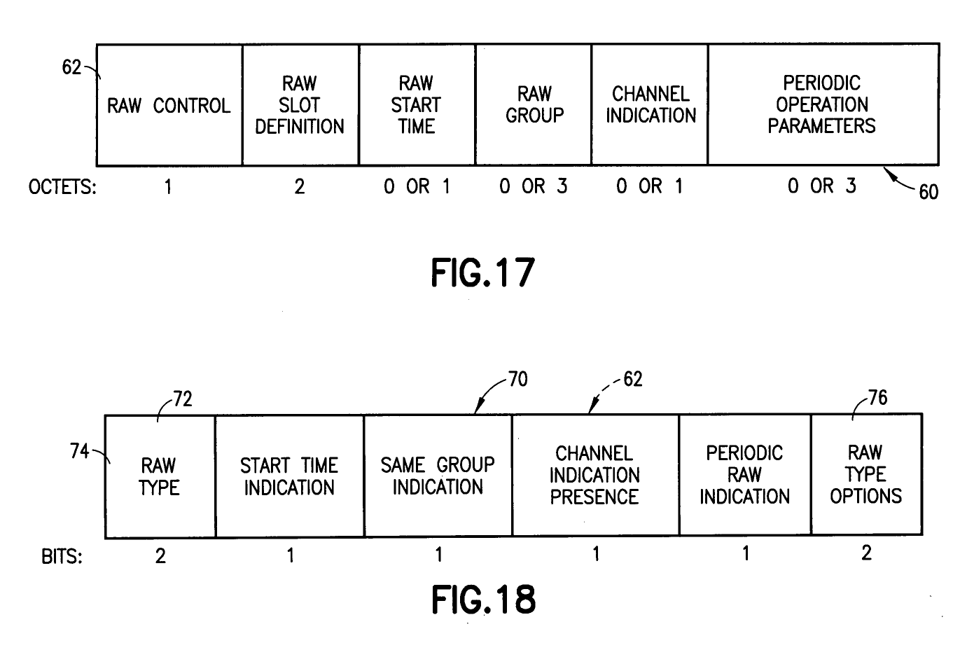

Referring also to FIG. 16, an example of the format 60 for the RAW Assignment fields 40 is shown. The RAW Assignment field format 60 includes a RAW Control field 62. FIG. 17 shows an example of the format 70 for the RAW Control field 62. In a situation where the Start Time Indication subfield 72 is set to 0 within the RAW Control subfield 62, i.e., the RAW Start Time field is not indicated in the RPS element. This is because the RAW (RAW 2) starts immediately after the previous RAW (RAW 1). In other words, RAW End Time of previous RAW (RAW 1) is equal to RAW Start Time for next RAW (RAW 2) or after the Beacon transmission, the NRAW Ind field 44 is not included. FIG. 16 shows an example of when the second RAW starts when the first RAW finishes. By not including the NRAW Indication field 44 in the RPS after the RAW assignment 40 for the first RAW (RAW 1) in this situation, this reduces the signaling overhead.

Rule for No Non-RAW Access:

If the first bit of each NRAW Ind after every RAW Assignment in the period between the two beacons is set to 1 then, from this situation, the STAs may be informed that there is no non-RAW access possible.

Rule for Non-RAW Access:

If the first bit of each NRAW Ind after every RAW Assignment is set to 0 then, from this situation, the STAs may be informed that there is non-RAW access possible before or after every RAW scheduled.

Rule for PRAW Indication with No Assigned NRAWs:

As noted above, and as shown by the example in FIG. 17, the RPS element consists of the RAW Control subfield 62 within the RAW Assignment field 40 of the format 60. Referring also to FIG. 18, a RAW Type 74 set to a two-bit settings in the RAW Control subfield 62, such as “10” for example, may be defined as a Simplex RAW with RAW Type Option field 76, Bit 3, Reserved. Other settings in field 76 may be, for example, Bit 0: AP PM RAW; Bit 1: Non-TIM RAW; Bit 2: Omni RAW. The Bit 3 in RAW Type Option field 76 may be used to define the PRAW assignment. For example, if this Bit 3 in option field is set, only the RAW Start Time and RAW Slot Definition subfields may be considered as being present in every RAW Assignment field 40 of the RPS element 54. All other fields are not included of the RPS element 54. In other words, if the Bit 3 in option field 76 is set, every RAW Assignment field 40 in the RPS element 54 may be treated as for PRAW Assignment.

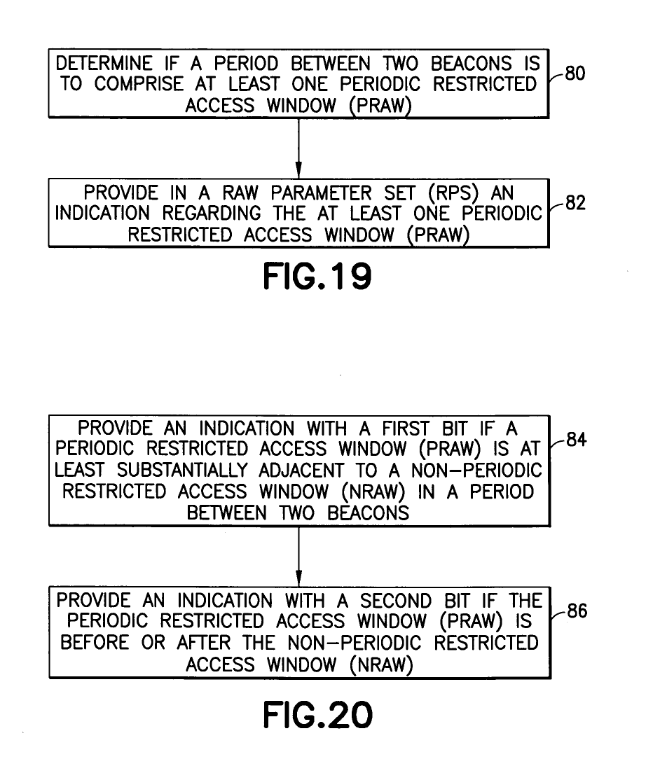

Referring also to FIG. 19, an example method may comprise determining if a period between two beacons is to comprise at least one Periodic Restricted Access Window (PRAW) as indicated by block 80, where at least one of the beacons comprises a Short Beacon (SB); and based upon the determining if the period comprises the at least one Periodic Restricted Access Window (PRAW), providing in a RAW Parameter Set (RPS) an indication regarding the at least one Periodic Restricted Access Window (PRAW) as indicated by block 82.

The RAW Parameter Set (RPS) may comprise an indication field following a RAW Assignment field, where the indication is in regard to the at least one Periodic Restricted Access Window (PRAW) relative to a respective Non-Periodic Restricted Access Window (NRAW) for that RAW Assignment field. The RAW Parameter Set (RPS) may comprise a plurality of the indication field, where each of the indication fields is associated with a separate RAW Assignment field in the RAW Parameter Set (RPS). The indication may comprise a first bit which indicates if the at least one Periodic Restricted Access Window (PRAW) is to occur substantially adjacent to a respective Non-Periodic Restricted Access Window (NRAW) in the period. The indication may comprise a second bit which indicates if the Periodic Restricted Access Window (PRAW) is before the Non-Periodic Restricted Access Window (NRAW) or after the Non-Periodic Restricted Access Window (NRAW). The method may further comprise a node using two of the indications in the RAW Parameter Set (RPS) for two different ones of the Non-Periodic Restricted Access Window (NRAW) in the period to indicate that a first one of the Periodic Restricted Access Windows (PRAWs) is before a Non-Periodic Restricted Access Window (NRAW) of the period and a second one of the Periodic Restricted Access Windows (PRAWs) is after the Non-Periodic Restricted Access Window (NRAW). The method may further comprise, when a second Non-Periodic Restricted Access Window (NRAW) is adjacent to a prior first Non-Periodic Restricted Access Window (NRAW) during the period, omitting the indication relative to a first RAW Assignment field of the RAW Parameter Set (RPS) for the first Non-Periodic Restricted Access Window (NRAW). The method may further comprise, by making a same bit of all of a plurality of the indications in the RAW Parameter Set (RPS) the same, indicated to at least one node that no Non-Restricted Access Window (NRAW) access is possible during the period. The method may further comprise, by making a same bit of all of a plurality of the indications in the RAW Parameter Set (RPS) the same, indicated to at least one node that Non-Restricted Access Window (Non-RAW) access is possible before and after each Non-Periodic Restricted Access Window (NRAW) in the period. The method may further comprise, in a RAW control field of a RAW Assignment field in the RAW Parameter Set (RPS), indicating that the period comprises at least one of the Periodic Restricted Access Window (PRAW) and comprises no Non-Periodic Restricted Access Window (NRAW).

An example embodiment may be provided in an apparatus comprising at least one processor; and at least one memory including computer program code, the at least one memory and the computer program code configured to, with the at least one processor, cause the apparatus at least: determine if a period between two beacons is to comprise at least one Periodic Restricted Access Window (PRAW), where at least one of the beacons comprises a Short Beacon (SB); and based upon the determining if the period comprises the at least one Periodic Restricted Access Window (PRAW), provide in a RAW Parameter Set (RPS) an indication regarding the at least one Periodic Restricted Access Window (PRAW).

An example embodiment may be provided in an apparatus comprising a non-transitory program storage device readable by a machine, tangibly embodying a program of instructions executable by the machine for performing operations, the operations comprising: determining if a period between two beacons is to comprise at least one Periodic Restricted Access Window (PRAW), where at least one of the beacons comprises a Short Beacon (SB); and based upon the determining if the period comprises the at least one Periodic Restricted Access Window (PRAW), providing in a RAW Parameter Set (RPS) an indication regarding the at least one Periodic Restricted Access Window (PRAW).

Referring also to FIG. 20, an example method may comprise providing an indication with a first bit if a Periodic Restricted Access Window (PRAW) is at least substantially adjacent to a Non-Periodic Restricted Access Window (NRAW) in a period between two beacons as indicated by block 84, where at least one of the beacons is a Short Beacon (SB); and providing an indication with a second bit if the Periodic Restricted Access Window (PRAW) is before or after the Non-Periodic Restricted Access Window (NRAW) as indicted by block 86. “Substantially adjacent” in this context merely means that the PRAW and NRAW are next to each other similar to that shown in FIG. 13 for example; such as with a small amount of time therebetween.

The first and second bits may be provided in an indication field in a RAW Parameter Set (RPS). The RAW Parameter Set (RPS) may comprise a plurality of the indication field, where each indication field follows a respectively associated RAW assignment field in the RAW Parameter Set (RPS). When Periodic Restricted Access Windows (PRAWs) are both before and after the Non-Periodic Restricted Access Window (NRAW), a node may use two of the indication fields in the RAW Parameter Set (RPS) for two different ones of the Non-Periodic Restricted Access Window (NRAW) in the period to indicate that a first one of the Periodic Restricted Access Windows (PRAWs) is before a Non-Periodic Restricted Access Window (NRAW) of the period and a second one of the Periodic Restricted Access Windows (PRAWs) is after the Non-Periodic Restricted Access Window (NRAW). The method may further comprise, when a second Non-Periodic Restricted Access Window (NRAW) is adjacent to a prior first Non-Periodic Restricted Access Window (NRAW) during the period, omitting the indication field relative to a first RAW Assignment field of the RAW Parameter Set (RPS) for the first Non-Periodic Restricted Access Window (NRAW). The method may further comprise, by making a same bit of all of a plurality of the indications in the RAW Parameter Set (RPS) a first value, indicated to at least one node that no Non-Restricted Access Window (Non-RAW) access is possible during the period, or by making the same bit of all of the plurality of the indications in the RAW Parameter Set (RPS) a different second value, indicated to the at least one node that Non-Restricted Access Window (Non-RAW) access is possible both before and after each Non-Periodic Restricted Access Window (NRAW) in the period. The method may further comprise, in a RAW control field of a RAW Assignment field in the RAW Parameter Set (RPS), indicating that the period comprises at least one of the Periodic Restricted Access Window (PRAW) and comprises no Non-Periodic Restricted Access Window (NRAW).

An example embodiment may be provided in an apparatus comprising at least one processor; and at least one memory including computer program code, the at least one memory and the computer program code configured to, with the at least one processor, cause the apparatus at least: provide an indication with a first bit if a Periodic Restricted Access Window (PRAW) is adjacent to a Non-Periodic Restricted Access Window (NRAW) in a period between two beacons, where at least one of the beacons is a Short Beacon (SB); and provide an indication with a second bit if the Periodic Restricted Access Window (PRAW) is before or after the Non-Periodic Restricted Access Window (NRAW).

An example embodiment may be provided in a non-transitory program storage device readable by a machine, tangibly embodying a program of instructions executable by the machine for performing operations, the operations comprising: providing an indication with a first bit if a Periodic Restricted Access Window (PRAW) is adjacent to a Non-Periodic Restricted Access Window (NRAW) in a period between two beacons, where at least one of the beacons is a Short Beacon (SB); and providing an indication with a second bit if the Periodic Restricted Access Window (PRAW) is before or after the Non-Periodic Restricted Access Window (NRAW).

Features as described herein may be used such that a Short Beacon (SB) includes, in addition to RAW assignment (for each NRAW) a two bit indicator (after each RAW assignment) to indicate: 1st bit indicates presence of PRAW adjacent to the specific NRAW, and 2nd bit indicates whether the adjacent PRAW is on left or right hand side of the NRAW. This may include the following assumptions:
There may be multiple NRAWs spaced apart of each other. This may happen if NRAW Slot boundary crossing is allowed, if we want to allow the last NRAW slot of previous NRAW to complete its transmission before next NRAW.
PRAWs close to the beacon transmission or towards the end of the Beacon interval, and apart from any NRAW can be neglected. Those can be neglected if PRAWs are seldom scheduled close to the end without being adjacent to NRAW.
There can be multiple PRAWs within SB. Distant TWT groups may require separate PRAWs
Indicating PRAW start time and duration (no other PRAW info) in SB may cause too much overhead.

An example embodiment may comprise means for determining if a period between two beacons is to comprise at least one Periodic Restricted Access Window (PRAW), where at least one of the beacons comprises a Short Beacon (SB); and based upon the determining if the period comprises the at least one Periodic Restricted Access Window (PRAW), means for providing in a RAW Parameter Set (RPS) an indication regarding the at least one Periodic Restricted Access Window (PRAW).

An example embodiment may comprise means for providing an indication with a first bit if a Periodic Restricted Access Window (PRAW) is at least substantially adjacent to a Non-Periodic Restricted Access Window (NRAW) in a period between two beacons, where at least one of the beacons is a Short Beacon (SB); and means for providing an indication with a second bit if the Periodic Restricted Access Window (PRAW) is before or after the Non-Periodic Restricted Access Window (NRAW).

With features as described herein, a Short Beacon (SB) may include, in addition to NRAW assignment (for each NRAW), such as RAW Assignments 40 shown in FIG. 13 corresponding to RAW 1 and RAW 2 for example, a two bit indicator (such as in indicators 44 after each RAW assignment field 40 for example) to indicate presence of a PRAW at least substantially adjacent to the specific NRAW (such as with a first bit in the indicators 44 for example), and indicate whether the PRAW is on left or right hand side of the NRAW (such as with a second bit in the indicators 44 for example).

An example method may comprise providing in a Short Beacon (SB) an indication regarding present of a Periodic Restricted Access Window (PRAW) in an interval partially defined by the Short Beacon (SB); and providing in the Short Beacon (SB) an indication that the Periodic Restricted Access Window (PRAW) is before a respective Non-periodic Restricted Access Window (NRAW) in the interval or after the Non-periodic Restricted Access Window (NRAW) in the interval. The Short Beacon (SB) may include multiple ones of the indications corresponding, respectively, to multiple PRAW during the interval. In one alternate example the indications may be a same single indication. In one example embodiment the indication regarding present of a Periodic Restricted Access Window (PRAW) in the interval may signal whether a PRAW is present or not present relative to a respective NRAW.

An example embodiment may be provided in an apparatus comprising at least one processor; and at least one memory including computer program code, the at least one memory and the computer program code configured, with the at least one processor, to cause the apparatus at least to: providing in a Short Beacon (SB) an indication regarding present of a Periodic Restricted Access Window (PRAW) in an interval partially defined by the Short Beacon (SB); and providing in the Short Beacon (SB) an indication that the Periodic Restricted Access Window (PRAW) is before a respective Non-periodic Restricted Access Window (NRAW) in the interval or after the Non-periodic Restricted Access Window (NRAW) in the interval.

An example embodiment may be provided in a non-transitory program storage device readable by a machine, tangibly embodying a program of instructions executable by the machine for performing operations, the operations comprising: include in a Short Beacon (SB) an indication regarding present of a Periodic Restricted Access Window (PRAW) in an interval partially defined by the Short Beacon (SB); and include in the Short Beacon (SB) an indication that the Periodic Restricted Access Window (PRAW) is before a respective Non-periodic Restricted Access Window (NRAW) in the interval or after the Non-periodic Restricted Access Window (NRAW) in the interval.

An example embodiment may be provided in an apparatus comprising means for providing in a Short Beacon (SB) an indication regarding present of a Periodic Restricted Access Window (PRAW) in an interval partially defined by the Short Beacon (SB); and means for providing in the Short Beacon (SB) an indication that the Periodic Restricted Access Window (PRAW) is before a respective Non-periodic Restricted Access Window (NRAW) in the interval or after the Non-periodic Restricted Access Window (NRAW) in the interval.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A method comprising:
determining if a period between two beacons is to comprise at least one Periodic Restricted Access Window (PRAW), where at least one of the beacons comprises a Short Beacon (SB); and
based upon the determining if the period comprises the at least one Periodic Restricted Access Window (PRAW), providing in a RAW Parameter Set (RPS) an indication regarding the at least one Periodic Restricted Access Window (PRAW).

2. A method as in claim 1 where the RAW Parameter Set (RPS) comprises an indication field following a RAW Assignment field in the RAW Parameter Set (RPS), where the indication is in regard to the at least one Periodic Restricted Access Window (PRAW) relative to a respective Non-Periodic Restricted Access Window (NRAW) for that RAW Assignment field.

3. A method as in claim 2 where the RAW Parameter Set (RPS) comprises a plurality of the indication field, where each of the indication fields is associated with a separate RAW Assignment field in the RAW Parameter Set (RPS).

4. A method as in claim 1 where the indication comprises a first bit which indicates if the at least one Periodic Restricted Access Window (PRAW) is to occur substantially adjacent to a respective Non-Periodic Restricted Access Window (NRAW) in the period.

5. A method as in claim 4 where the indication comprises a second bit which indicates if the Periodic Restricted Access Window (PRAW) is before the Non-Periodic Restricted Access Window (NRAW) or after the Non-Periodic Restricted Access Window (NRAW).

6. A method as in claim 1 further comprising a node using two of the indications in the RAW Parameter Set (RPS) for two different Non-Periodic Restricted Access Windows (NRAWs) in the period to indicate that a first one of the Periodic Restricted Access Windows (PRAWs) is before one of the Non-Periodic Restricted Access Windows (NRAWs) of the period and a second one of the Periodic Restricted Access Windows (PRAWs) is after the Non-Periodic Restricted Access Window (NRAW).

7. A method as in claim 1 further comprising, when a second Non-Periodic Restricted Access Window (NRAW) is adjacent to a prior first Non-Periodic Restricted Access Window (NRAW) during the period, omitting the indication relative to a first RAW Assignment field of the RAW Parameter Set (RPS) for the first Non-Periodic Restricted Access Window (NRAW).

8. A method as in claim 1 further comprising, by making a same bit of all of a plurality of the indications in the RAW Parameter Set (RPS) the same, indicating to at least one node that no Non-Restricted Access Window (Non-RAW) access is possible during the period.

9. A method as in claim 1 further comprising, by making a same bit of all of a plurality of the indications in the RAW Parameter Set (RPS) the same, indicating to at least one node that Non-Restricted Access Window (Non-RAW) access is possible before and after each Non-Periodic Restricted Access Window (NRAW) in the period.

10. A method as in claim 1 further comprising, in a RAW control field of a RAW Assignment field in the RAW Parameter Set (RPS), indicating that the period comprises at least one of the Periodic Restricted Access Window (PRAW) and comprises no Non-Periodic Restricted Access Window (NRAW).

11. A method as in claim 10 where the indicating, that the period comprises at least one of the Periodic Restricted Access Window (PRAW) and comprises no Non-Periodic Restricted Access Window (NRAW), comprises a RAW type option field of the RAW Control field indicating that the period comprises at least one of the Periodic Restricted Access Window (PRAW) and comprises no Non-Periodic Restricted Access Window (NRAW), and that only RAW Start Time and RAW Slot Definition subfields are present in every RAW Assignment filed of the RAW Parameter Set (RPS).

12. An apparatus comprising:
at least one processor; and
at least one memory including computer program code, the at least one memory and the computer program code configured to, with the at least one processor, cause the apparatus at least:
determine if a period between two beacons is to comprise at least one Periodic Restricted Access Window (PRAW), where at least one of the beacons comprises a Short Beacon (SB); and
based upon the determining if the period comprises the at least one Periodic Restricted Access Window (PRAW), provide in a RAW Parameter Set (RPS) an indication regarding the at least one Periodic Restricted Access Window (PRAW).

13. A non-transitory program storage device readable by a machine, tangibly embodying a program of instructions executable by the machine for performing operations, the operations comprising:
determining if a period between two beacons is to comprise at least one Periodic Restricted Access Window (PRAW), where at least one of the beacons comprises a Short Beacon (SB); and
based upon the determining if the period comprises the at least one Periodic Restricted Access Window (PRAW), providing in a RAW Parameter Set (RPS) an indication regarding the at least one Periodic Restricted Access Window (PRAW).

14. A method comprising:
providing an indication with a first bit if a Periodic Restricted Access Window (PRAW) is at least substantially adjacent to a Non-Periodic Restricted Access Window (NRAW) in a period between two beacons, where at least one of the beacons is a Short Beacon (SB); and
providing an indication with a second bit if the Periodic Restricted Access Window (PRAW) is before or after the Non-Periodic Restricted Access Window (NRAW).

15. A method as in claim 14 where the first and second bits are provided in an indication field in a RAW Parameter Set (RPS).

16. A method as in claim 15 where the RAW Parameter Set (RPS) comprises a plurality of the indication field, where each indication field follows a respectively associated RAW assignment field in the RAW Parameter Set (RPS).

17. A method as in claim 15 where, when Periodic Restricted Access Windows (PRAWs) are both before and after the Non-Periodic Restricted Access Window (NRAW), a node using two of the indication fields in the RAW Parameter Set (RPS) for two different ones of the Non-Periodic Restricted Access Window (NRAW) in the period to indicate that a first one of the Periodic Restricted Access Windows (PRAWs) is before a Non-Periodic Restricted Access Window (NRAW) of the period and a second one of the Periodic Restricted Access Windows (PRAWs) is after the Non-Periodic Restricted Access Window (NRAW).

18. A method as in claim 15 further comprising, when a second Non-Periodic Restricted Access Window (NRAW) is adjacent to a prior first Non-Periodic Restricted Access Window (NRAW) during the period, omitting the indication field relative to a first RAW Assignment field of the RAW Parameter Set (RPS) for the first Non-Periodic Restricted Access Window (NRAW).

19. A method as in claim 15 further comprising, by making a same bit of all of a plurality of the indications in the RAW Parameter Set (RPS) a first value, indicated to at least one node that no Non-Restricted Access Window (Non-RAW) access is possible during the period, or by making the same bit of all of the plurality of the indications in the RAW Parameter Set (RPS) a different second value, indicated to the at least one node that Non-Restricted Access Window (Non-RAW) access is possible both before and after each Non-Periodic Restricted Access Window (NRAW) in the period.

20. A method as in claim 15 further comprising, in a RAW control field of a RAW Assignment field in the RAW Parameter Set (RPS), indicating that the period comprises at least one of the Periodic Restricted Access Window (PRAW) and comprises no Non-Periodic Restricted Access Window (NRAW).

21. A method as in claim 20 where the indicating, that the period comprises at least one of the Periodic Restricted Access Window (PRAW) and comprises no Non-Periodic Restricted Access Window (NRAW), comprises a RAW type option field of the RAW Control field indicating that the period comprises at least one of the Periodic Restricted Access Window (PRAW) and comprises no Non-Periodic Restricted Access Window (NRAW), and that only RAW Start Time and RAW Slot Definition subfields are present in every RAW Assignment filed of the RAW Parameter Set (RPS).

22. An apparatus comprising:
at least one processor; and
at least one memory including computer program code, the at least one memory and the computer program code configured to, with the at least one processor, cause the apparatus at least:
provide an indication with a first bit if a Periodic Restricted Access Window (PRAW) is adjacent to a Non-Periodic Restricted Access Window (NRAW) in a period between two beacons, where at least one of the beacons is a Short Beacon (SB); and
provide an indication with a second bit if the Periodic Restricted Access Window (PRAW) is before or after the Non-Periodic Restricted Access Window (NRAW).

23. A non-transitory program storage device readable by a machine, tangibly embodying a program of instructions executable by the machine for performing operations, the operations comprising:
providing an indication with a first bit if a Periodic Restricted Access Window (PRAW) is adjacent to a Non-Periodic Restricted Access Window (NRAW) in a period between two beacons, where at least one of the beacons is a Short Beacon (SB); and
providing an indication with a second bit if the Periodic Restricted Access Window (PRAW) is before or after the Non-Periodic Restricted Access Window (NRAW).

24. A method comprising:
providing in a Short Beacon (SB) at least one indication regarding present of at least one Periodic Restricted Access Window (PRAW) in an interval partially defined by the Short Beacon (SB); and
providing in the Short Beacon (SB) at least one indication that the Periodic Restricted Access Window (PRAW) is before a respective Non-periodic Restricted Access Window (NRAW) in the interval or after the Non-periodic Restricted Access Window (NRAW) in the interval.
